(19) United States
(12) Patent Application Publication
(10) Pub. No.: US 2008/0219579 A1
(43) Pub. Date: Sep. 11, 2008

(54) Methods and Apparatus for Compressed Imaging Using Modulation in Pupil Plane

(76) Inventors: Vladimir A. Aksyuk, Westfield, NJ (US); Raymond A. Cirelli, Hillsborough, NJ (US); John V. Gates, New Providence, NJ (US); George P. Watson, Avon, NJ (US)

Correspondence Address: Ryan, Mason & Lewis, LLP, Suite 205, 1300 Post Road, Fairfield, CT, 06824, US

(21) Appl. No.: 11/940,679

(22) Filed: Nov. 15, 2007

Related U.S. Application Data
(60) Provisional application No. 60/892,998, filed on Mar. 5, 2007.

(51) Int. Cl. G06K 9/36; G06K 9/76

(52) U.S. Cl. 382/248; 382/211

(57) ABSTRACT

Methods and apparatus are provided for compressed imaging by performing modulation in a pupil plane. Image information is acquired by modulating an incident light field using a waveplate having a pattern that modifies a phase or amplitude of the incident light field, wherein the waveplate is positioned substantially in a pupil plane of an optical system; optically computing a transform between the modulated incident light field at a plane of the waveplate and an image plane; and collecting image data at the image plane. The transform can be, for example, a Fourier transform or a fractional Fourier transform

### CROSS-REFERENCE TO RELATED APPLICATION

The present application claims the benefit of U.S. Provisional Patent Application Ser. No. 60/892,998, filed Mar. 5, 2007, incorporated by reference herein.

### FIELD OF THE INVENTION

The present invention relates generally to techniques for acquiring a compressed digital representation of a signal, and more particularly, to methods and apparatus for directly acquiring a compressed digital representation of a signal

### BACKGROUND OF THE INVENTION

Data compression techniques encode information using fewer bits than an unencoded representation of the information. Data compression techniques typically exploit known information about the data. For example, image compression techniques reduce redundancy of the image data in older to transmit or store the image data in an efficient form A number of image compression techniques exploit the fact that an image having N pixels can be approximated using a sparse linear combination of the K largest wavelets, where K is less than N The K wavelet coefficients are computed from the N pixel values and are stored (or transmitted) along with location information. Generally, compression algorithms employ a decorrelating transform to compact the energy of a correlated signal into a small number of the most important coefficients Transform coders thus recognize that many signals have a sparse representation in terms of some basis

Conventional data compression techniques typically acquire the raw data (such as the N pixel values), process the raw data to keep only the most important information (such as the K largest wavelets or coefficients) and then discard the remaining data When N is much larger than K, this process is inefficient. Compressive Sensing (CS) techniques have been proposed for directly acquiring a compressed digital representation of a signal (without having to first completely sample the signal) Generally, Compressive Sensing techniques employ a random linear projection to acquire compressible signals directly Compressive Sensing techniques attempt to directly estimate the set of coefficients that are retained (i e, not discarded) by the encoder A signal that is K-sparse in a first basis (referred to as the sparsity basis) can be recovered from cK non-adaptive linear projections onto a second basis (referred to as the measurement basis) that is incoherent with the first basis, where c is a small oversampling constant.

Some compressive Imaging cameras directly acquire random projections of the incident light field without first collecting the pixel values (or voxels for three-dimensional images) The cameras employ a digital micromirror device (DMD) to perform optical calculations of linear projections of an image onto pseudo-random binary patterns. An incident light field, corresponding to a desired image, passes through a lens and is then reflected off the DMD array, whose mirror orientations are modulated based on a pseudorandom pattern sequence supplied by a random number generator The reflected light is collected and summed by a single photodiode Each different mirror pattern produces a voltage level at the single photodiode detector that corresponds to one measurement, y(m). The voltage level is then quantized by an analog-to-digital converter. The generated bitstream is then communicated to a reconstruction algorithm that yields the output image

While such compressive Imaging camera may work well for many applications, they suffer from a number of limitations, which if overcome, could further improve such compressive imaging techniques. In particular, some compressive imaging cameras require a reconfigurable DMD array that increases the cost of fabrication and the complexity of the optical alignment Such reconfigurable elements may not be available or may be technically difficult to manufacture at the diffraction limits required for high resolution images In addition, the speed of the DMD array limits the acquisition rate of image sequences.

A need therefore exists for improved Compressed Imaging cameras that do not require reconfigurable elements Additionally, with some compressive Imaging cameras, additional imaging optics may be requited to collect the light reflected from the DMD and direct the light towards the detector. A further need therefore exists for improved Compressed Imaging cameras that do not require such additional imaging optics. Yet another need exists for improved compressed imaging techniques that acquire the image data simultaneously, in parallel with an array of detectors, in a similar manner to CCD (Charge Coupled Device) cameras or CMOS (Complementary Metal-Oxide Semiconductor) cameras.

### SUMMARY OF THE INVENTION

Generally, methods and apparatus are provided for compressed imaging using modulation in a pupil plane. According to one aspect of the invention, image information is acquired by modulating an incident light field using a waveplate having a pattern that modifies a phase or amplitude of the incident light field, wherein the waveplate is positioned substantially in a pupil plane of an optical system; optically computing a transform between the modulated incident light field at a plane of the waveplate and an image plane; and collecting image data at the image plane. The transform can be, for example, a Fourier transform or a fractional Fourier transform.

The waveplate can have a fixed or reconfigurable pattern to modify the phase or amplitude of the incident light field. The acquired image information can be two-dimensional or three-dimensional image information The image data can be collected, for example, using a plurality of sparsely spaced small pixels or a plurality of sparsely or densely packed large pixels.

A more complete understanding of the present invention, as well as further features and advantages of the present invention, will be obtained by reference to the following detailed description and drawings

### BRIEF DESCRIPTION OF THE DRAWINGS

FIG. 1 illustrates a schematic block diagram of a conventional Compressive Imaging camera system;

FIG. 2 is a schematic block diagram of a Compressive Imaging camera system in accordance with a transmissive implementation of the present invention;

FIG. 3 illustrates an exemplary point spread function for an exemplary optical system; and

FIG. 4 illustrates an exemplary implementation of a single exemplary patterned pixel for the detector array of FIG. 2 embodied using a small number of patterned, densely spaced large pixels

### DETAILED DESCRIPTION

The various embodiments provide methods and apparatus for acquiring image information. Information can be acquired by computing a set of projections of the signal vector onto a subset of vectors of some properly chosen measurement basis. It is assumed that the signal vectors are compressible, and specifically that they belong to a set of vectors for which a special basis exists (sparsity basis) in which all the vectors of the set are sparse, i.e can be to a good approximation expressed as a linear combination of only a small number of the basis vectors. The phrase “to a good approximation” may mean, for example, that the modulus of the error is a factor of 10 or more smaller than the modulus of the signal vector The phrase “a small number” may mean, for example, fewer vectors than the full dimensionality of the vector space by a factor of 3 or more or by a factor of 10 or more. Signal vectors corresponding to many real life images are compressible in this way.

It is noted that the measurement basis is defined by, for example, the waveplate shape and position, optical elements and detector pixel positions and shapes, such that detector output values are projections of (scalar products of) a signal vector onto vectors of the measurement basis. As discussed further below, to be able to reconstruct the original compressible signal from these measurements, a measurement basis should be chosen that is incoherent with the sparsity basis of the signals to be measured For example, the matrix expressing the measurement basis vectors through the sparsity basis vectors should not itself be sparse Such incoherent projections can be acquired by the disclosed optical system.

According to one embodiment, a filter or waveplate is positioned substantially in a pupil plane of an optical system. The waveplate may be embodied, for example, as reconfigurable spatial light modulators (SLM) or a fixed piece of shaped glass. The waveplate modulates an incident light field and has a pattern that locally modifies one or more of a phase and an amplitude of the incident light field. The optics is arranged in such a way that the light field in the image plane is essentially a known transform of the light field in the plane of the waveplate The optics, such as one or more lenses, positioned in between the two planes, determine the relationship between the modulated incident light field in the plane of the waveplate and the lightfield in the image plane. A transform, such as a Fourier transform, is optically computed between the modulated incident light field at a plane of the waveplate and an image plane. It is noted that the field in the image plane can be, for example, a Fourier Transform of the field after the waveplate. The image data is collected at the image plane with multiple detectors. The waveplate, optical system and detectors collectively implement the requisite projections of the input optical signal vector onto the measurement basis, where the measurement basis is incoherent with the sparsity basis. Each detector output signal is a scalar value corresponding to the projection (i.e. scalar product) of the signal vector onto one of the vectors of the measurement basis.

While the embodiments are illustrated herein in the context of optically incoherent imaging, i.e., imaging a scene consisting of mutually incoherent light sources, other embodiments can also be applied in the context of optically coherent imaging, as would be apparent to a person of ordinary skill in the art

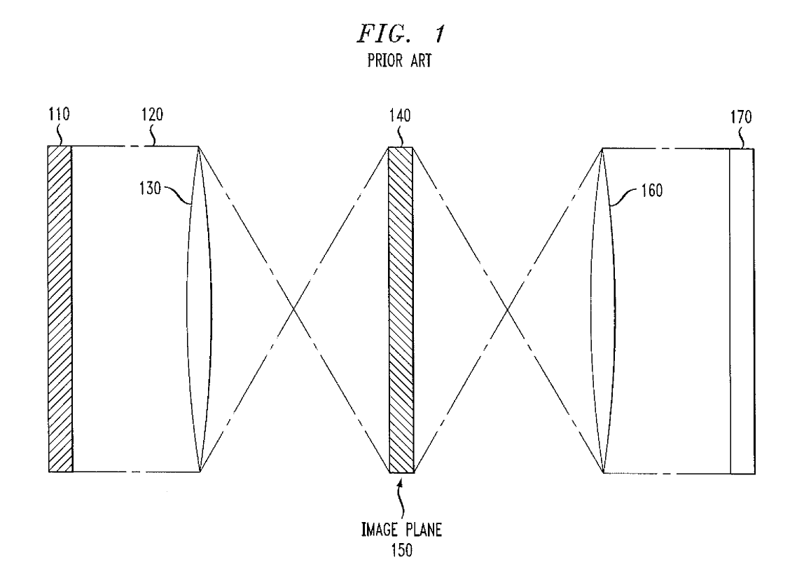

FIG. 1 illustrates a schematic block diagram of a conventional Compressive Imaging camera system 100 in accordance with a transmissive implementation of the teachings of U.S. patent application Ser. No. 11/379,688, to Baraniuk et al., entitled “Method and Apparatus for Compressive Imaging Device.” As shown in FIG. 1, incident light 120 corresponding to a desired object 110 is focused by a lens 130 on a DMD array 140, positioned at an image plane of the optical system Generally, the panels of the digital micro-mirror array 140 are modulated in a pseudorandom pattern. Generally, each mirror in the array 140 essentially blocks or passes the light from the corresponding area of the image onto a corresponding cell of a photodetector 170, where all the light energy is summed. Each different mirror pattern produces a different voltage at a photodetector 170 (where re-imaging occurs).

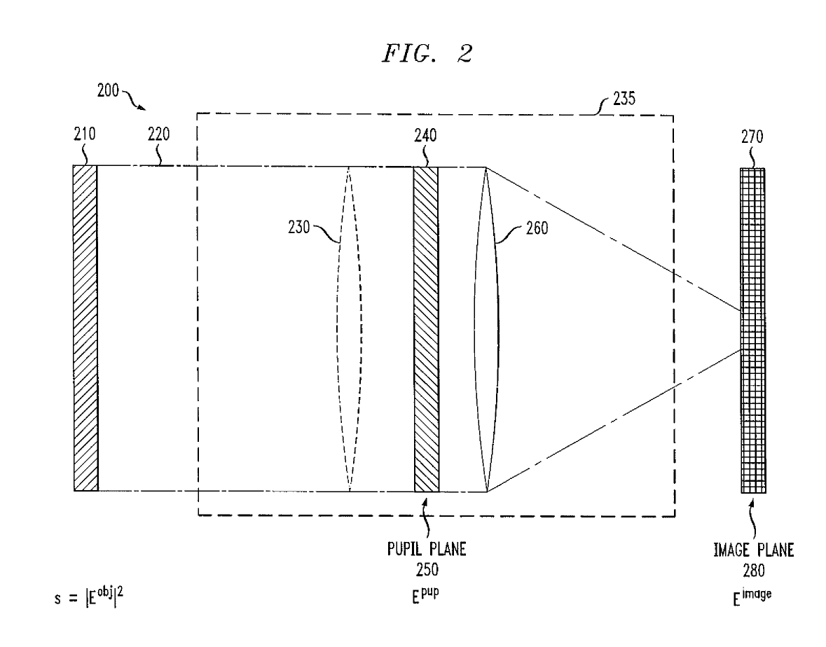

FIG. 2 is a schematic block diagram of a Compressive Imaging camera system 200 in accordance with a transmissive implementation of the present invention. As shown in FIG. 2, incident light 220 corresponding to a desired object 210 is focused by an optional lens 230 and a lens 260 on a detector array 270 in the image plane 280 As discussed further below, a modulating waveplate 240 is positioned substantially at a pupil plane 250 of the imaging optical system 200. The pupil plane of an idealized imaging optical system is a plane in which the optical field is essentially a Fourier transform of the field in the image plane. The plate 240 can also be positioned slightly away from the exact pupil plane 250 of the optical system, such as the first optical element directly in front of the one or more of the lenses 230, 260 of an imaging system 235, or between or behind such lenses 230, 260. If moved from the precise pupil plane, the permissible positions of the waveplate 240 can be determined, for example, by calculation or experimentation, to determine the threshold position at which the imaging system can no longer acquire projections incoherent with the signal sparsity basis and the image cannot be reconstructed.

Generally, if the plate is positioned away from the pupil plane, two things happen. First, the optical system becomes not isoplanatic (i.e., the impulse response (point spread function) is no longer the same across the image field). For example, the image of a point source located on the optical system axis is not the same as the image of a point source located at an angle to such axis. Second, the “contrast” of the point spread functions (PSFs) possible with a phase-only plate will likely decrease, making the measurement less efficient, decreasing information throughput and quality of reconstruction in the presence of noise The exact details depend on the specifics of the situations. However, if the shape and position of the plate are known, then the measurements are known, and so the reconstruction in the presence of detector noise can be attempted experimentally or even modeled for various images. For a given plate shape, the reconstruction error will likely increase and reconstruction quality will likely decrease as the plate is moved away from the optimal position. Also, the reconstruction problem may become more computationally intensive This decrease in quality can be measured or modeled.

As a rule of thumb for plate positioning, if the plate is positioned in front of the lens, the distance from the object to the first principal plane of the lens should be much larger (e.g., by a factor of 10) than the distance from the plate to the plane If the plate is positioned behind the lens, the distance from the second principal plane of the lens to the image plane, or the plane of the detectors, should be much larger than the distance from the second principal plane to the plate. If the plate is positioned within the lens, it would be sufficient to satisfy both rules, but it may be unnecessary.

The modulating waveplate 240 has a pattern that locally modifies one or more of a phase and an amplitude of the incident light field 220 based on a pattern. For example, to alter the phase of the incident light field 220, the exemplary modulating waveplate 240 is transparent with an index of refraction other than unity, and where the thickness of the modulating waveplate 240 varies spatially based on a specific pattern. The variable thickness of the modulating waveplate 240 will alter the phase of the incident light field 220 on a location-by-location basis. The plate 240 can have a thickness that has specified values at the nodes of the grid and is smoothly varying between such nodes, or can be piecewise constant Likewise, to alter the amplitude of the incident light field 220, the exemplary modulating waveplate 240 is comprised of a grid of elements, where the transmissive properties of the modulating waveplate 240 vary based on a specific pattern The pattern is chosen to implement an incoherent measurement basis and can be calculated as described below

While a transmissive plate is being described, a reflective element may also be used, such as a corrugated mirror with a pre-specified shape or a mirror consisting of an array of individual segments positioned at different heights. Such segments can be stationary or movable, such as moving up and down on a piston, e.g, a MEMS controlled pistons Such a reflective element may be placed, for example, essentially in front of an imaging system or close to any plane that is substantially conjugate to the pupil plane.

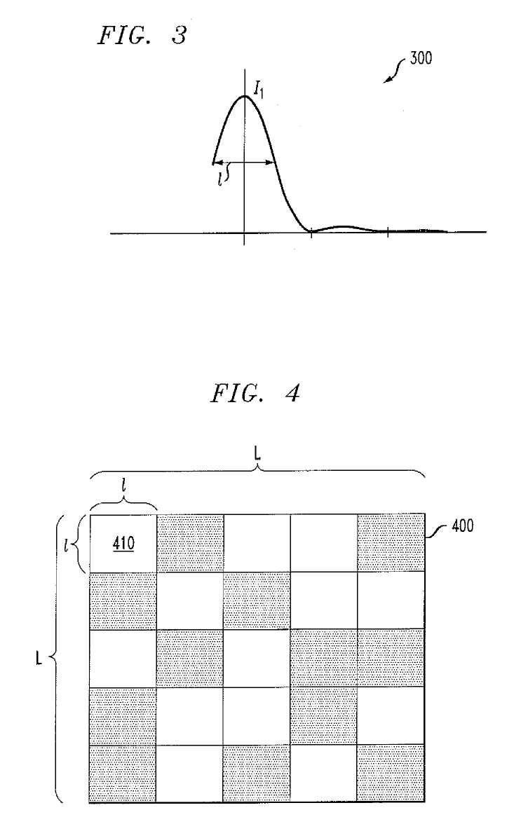

The determination of a desired thickness pattern for the modulating waveplate 240 is discussed further below in conjunction with FIG. 3

As shown in FIG. 2, after the incident light 220 is modulated by the modulating waveplate 240, a transform is optically computed between the modulated incident light field at a plane of the waveplate 240 and an image plane 280. In particular, since the modulating waveplate 240 is positioned substantially at or near a pupil plane 250 of the optical system 200, the Fourier transform or a fractional Fourier transform is optically computed by appropriately selecting and positioning the one or more lenses 230, 260 in front of the image plane 280 with a detector array 270 for collecting the image data

Although the exemplary camera system 200 is shown as having a lens system 235 comprised of two lenses 230 and 260, the lens system 235 can be implemented with one or more lenses, as would be apparent to a person of ordinary skill in the art.

Field in the Object Plane

In most imaging systems, light can be described by a spatially and temporally varying complex scalar field expressed here by function E. The intensity of light at a given point is given by the square of the amplitude, |E|².

In an idealized isoplanatic imaging system, such as the exemplary camera system 200 of FIG. 2, the intensity of the image i formed in the image plane 280 in response to the observed object optical signal s is given by:

i=s*PSF

where * denotes a convolution, and PSF is the Point Spread Function of the optical system, comprised of the lens system 235 and the modulating waveplate 240. See, for example, E. G Steward, “Fourier Optics, an Introduction,” Dover Publications (2d ed, 2004).

It is noted that in the following, the variable x is employed to denote a one- or two-dimensional coordinate in the image plane 280, and the variable y is used to denote a one- or two-dimensional coordinate in the pupil plane 250

It is noted that the observed object optical signal s can be expressed as a function of the field of the object plane, E^{obj}, as follows:

s=E^{obj}|²,

In other words, s can be expressed as the square of the modulus of the field at the object plane, E^{obj} As shown in FIG. 2, the field at the pupil plane 250 can be expressed as E^{pup} The modulated signal departing the pupil plane 250 can be expressed as E^{pup} multiplied by an aperture function, f(y), given by the modulating waveplate 240 and the aperture of the lens 230, 260 Finally, the light arriving at the image plane 280 can be expressed as E^{image}, where

E^{image}=FT{E^{pup}·f(y)}.

where f(y) is the aperture function of the modulating waveplate 240, and FT denotes a Fourier transform, that is the result of the propagation of the light field through the optical system 235.

For example, for an exemplary round aperture (without the plate or in the case of a flat and transparent plate), the aperture function can be expressed as follows:

f(y)={1 for |y|<=R;0 otherwise}

Field in the Image Plane 280

The image is typically digitized by a detector 270, such as a CMOS or CCD sensor, located in the image plane 280, consisting of a one- or two-dimensional array of typically identical pixels, such that each pixel integrates (sums) the light energy (intensity) falling onto the specific pixel area. For simplicity and without limitation, pixels will be assumed identical below. Pixels are also typically equidistantly spaced, but do not have to be. The response, rⱼ, of the j-th pixel located at xⱼ to a given image intensity i(x) can be expressed as:

rⱼ=r(xⱼ)=i*p

where p(x) is referred to as a pixel response function For example, for an idealized square pixel of lateral size, L, in two dimensions,

p(x)={1 if −L/2<=x¹<=+L/2 and −L/2<=x²<=+L/2;0 otherwise}

Thus,

r=s*PSF*p=s*F,

where F is a filter function defined for convenience as:

F=PSF*p

The filter function F can thus be controlled by appropriately modifying the pixel response function p and the optical system PSF The output of the sensor 270 is an n-dimensional vector with the following components:

rⱼ=r(xⱼ),j=1. . . n,

where n is the number of pixels in the sensor 270.

In addition to the selection of F, the output of the sensor 270 is also controlled by the location of each pixel xⱼ. However, typically the pixels are located on a uniform one- or two-dimensional grid. For example, in two dimensions, where j=(k, l):

xₖ¹=a k k=1. . . N

xₗ²=a l l=1 . . . N

where a is the step size

Field in the Pupil Plane 250

The PSF (or the optical impulse response) of an idealized isoplanatic incoherent optical imaging system 235 is a real-valued non-negative function and can be expressed as follows:

PSF(x)=|FT{f(y)}|²

where f(y) is the aperture function defined above and the exemplary optical imaging system 235 comprises one or more lenses 230, 260 and the modulating waveplate 240 When f(y) is defined by a simple circular aperture, as described in an example above, this gives rise to the PSF in the form of a well known Airy pattern.

The PSF can be modified by choosing the appropriate aperture function, f The aperture function, f, is a complex function of y, reflecting the fact that the phase and amplitude of the light can be modified at the aperture. Specifically, a fully transparent glass plate 240 of variable thickness t(y) placed in front of the lens would introduce a phase shift, for small t(y) of order a few wavelengths, modifying the aperture function of the modulating waveplate 240, as follows:

f(y)={exp(i2η(η−1)t(y)/λ)for |y|<=R0 otherwise}

where i=\sqrt{−1}, η is the index of refraction and λ is the wavelength. Thus, the phase of the aperture function, f, indicates how much the light is retarded by the modulating waveplate 240. The amplitude of the aperture function, f, indicates how much the light intensity is altered by the modulating waveplate 240.

Although one can also change f(y) by changing its amplitude through varying absorption or reflection as a function of y, often it is advantageous to vary only phase from two standpoints. First, using a fully transparent plate 240 often leads to more efficient utilization of incoming light and thus a higher signal to noise ratio Second, a fully transparent plate 240 may be easier to manufacture.

If the desired PSF is known, the thickness variation required to approximate such PSF around a specific wavelength, λ, can be calculated by finding the complex f(y) that minimizes the following expression:

∥|FT{f(y)}|²−PSF∥subject to {|f(y)=1 for |y|<=R and |f(y)|=0 for |y|>R}

This belongs to a well known phase retrieval class of problems and can be solved numerically with known methods See, for example, J R Fienup, “Phase Retrieval Algorithms: A Comparison,” Applied Optics, Vol. 21, No. 15 (August 1982)

Alternative waveplates can be designed by minimizing the above expression subject to different boundary conditions. For example, f=1 or 0 can be used for designing a mask that has a fully transparent or fully opaque pattern, f=−/−1 can be used for a binary phase mask. For a given PSF, the appropriate f can be calculated by solving the above stated optimization problem. The problem can be solved by a variety of known numerical methods. If a plate is then used implementing the resulting function f(y), the PSF of the optical system will be approximately the desired PSF.

Generally, these principles are used to determine the appropriate thickness profile, t(y), for the modulating waveplate 240 that provides the appropriate aperture function, f, that gives the desired PSF.

When using such methods, continuous functions are approximated by specifying values of these functions on nodes of typically regular grids. When the desired thickness has been computed on the grid, the actual plate can be fabricated with such thickness profile that has the same values as calculated on the grid nodes, and that varies smoothly between the nodes. It is noted that care should be taken to choose the appropriate grids.

Fabrication and Grid Size of Waveplate

It is noted that the rate of variation or the high spatial frequency content of the PSF is limited by the finite support of f(y), such as R in the above example, which gives the appropriate grid density sufficient for representing PSF and FI {f}

The grid size for the PSF of the optical system 235 is given by the desired spatial extent of the PSF, and defines the grid density for f(y) to appropriately represent the required spatial frequency content Generally, a larger extent of the PSF leads to higher spatial frequencies in f(y)

FIG. 3 illustrates a PSF 300 for an exemplary optical system without a waveplate, such as an optical system comprised of the two lenses 230, 260. A PSF is characterized by its characteristic scale, l, in a known manner. The horizontal axis indicates the position, x, in the image plane and the vertical axis indicates the value of the PSF As shown in FIG. 3, for the exemplary PSF 300, the characteristic scale, l, may be measured approximately halfway below the maximum intensity As described below, when a random PSF is specified, it should be specified on a grid with a step size substantially larger or equal to l, since no function f(y) can be found with the finite support given by R, that would result in a more rapidly varying PSF.

The grid for specifying the aperture function f(y) should also be selected sufficiently dense to accurately represent the required thickness profile. This can be accomplished for example by selecting the size of the PSF grid several times larger than needed to express all the substantially non-zero elements of the PSF, i.e., padding the PSF with zeroes. This will result in the f(y) grid being sufficiently dense

The exact shape of the plate is determined by the process used to produce it, as would be apparent to a person of ordinary skill in the art. The fabrication process can include, for example, etching into a flat glass plate or a machining and polishing technique. The resulting profile can consist of steps of various heights t(y), i e., grid elements of various heights, possibly a set of squares of two or more different height levels, or a plate with a smooth surface that would more likely result from polishing

The plate can be fabricated, for example, from glass or a transparent plastic or another material that is transparent and that can be appropriately shaped. For example, the plate 240 can potentially be made out of Silicon, which is transparent for infrared wavelengths. The plate 240 can also consist of several materials, as long as it can produce an appropriate phase shift of the incoming lightwave

The plate 240 can optionally have a variable absorption characteristic, to produce the appropriate intensity modulation of the incoming lightwave For example, the plate 240 can be a mask containing a patterned layer of opaque or partially absorbing or fully or partially reflective material on glass or another transparent substrate. The plate 240 can be produced with a lithography process similar to producing photomasks for optical lithography in semiconductor manufacturing The plate 240 can also be made out of one or more layers of plastic with some type of embossing or imprinting technique to shape the plastic to the appropriate height profile.

Good “Summary” from Coarse Detection

In accordance with the teachings of J. A. Tropp et al, “Random Filters for Compressive Sampling and Reconstruction,” Proc. Int'l Conf Acoustics, Speech, Signal Processing, (May 2006), which article is incorporated herein by reference in its entirety, if the above-mentioned filter function F represents an FIR filter with B random taps, then when a “compressible” signal is down-sampled as follows:

rⱼ=s*F(xⱼ)

where xⱼ is a coarse grid, such sampling provides a “good summary” of the signal, i.e., if the “sparsity basis” of the original compressible signal is known, the original signal may be reconstructed with good accuracy from the summary data rⱼ.

For systems that are not exactly isoplanatic, such as the case where the waveplate is positioned away from the precise pupil plane 250, the system can be approximated as isoplanatic over regions of the image plane, F^{m}(xⱼ), defined for each region, m

There can also be other random or even non-random functions F (other than FIR filters with random taps) that lead to good summaries through the procedure outlined above for compressible signals.

The full Nyquist rate needed to digitize the signal in one- or two-dimensions is given by the highest spatial frequency of the diffraction-limited image of such signal when imaged through the finite aperture of the imaging system. This rate is given either by the characteristics of the signal itself, or by the diffraction limited filtering of the finite aperture. Suppose the corresponding length scale of the PSF in the image plane is of order l (see FIG. 3)

A random-tap FIR filter F can be created by requiring that the values of F on the grid with step size of order l be random. The number of taps B can be chosen by changing the number of grid elements with essentially non-zero values of F.

Since natural scenes are typically locally compressible (redundant), i.e., blocks of size<L can be efficiently compressed, it is good to have the support of F be of a size larger than L, to create a good summary.

### Sparsely Spaced Small Pixel Embodiment

The random tap FIR F can be implemented approximately by making individual pixels small: size of sup(p)<l, and using the relationship F=PSF*p to obtain the desired PSF by de-convolution. Once the desired PSF is obtained, the thickness of the variable thickness plate 240 can be calculated as described above In this “pin hole” pixel embodiment, the p function is essentially a delta function, and the PSF alone provides a sufficient summary.

In the resulting imaging system, a smaller number of sparsely placed small pixels in the image plane would be sufficient to create a good reconstruction of the image which would otherwise require a large number of similar pixels densely packed. Pixels are sparsely spaced when the pixel active area is much less than the inactive area between pixels, e.g., a factor of 10 or more difference

Alternatively, in an optical imaging system that has a large number of densely spaced small pixels, data from only a fraction of such pixels may be sufficient to reconstruct a compressible image This may be beneficial particularly in those cases where data from all the pixels can not be read, for example, due to time limitations of capturing a rapidly changing scene or other limitations This technique can be extended to capturing high resolution video of rapidly changing scenes.

This technique may be particularly advantageous for capturing compressible video. A time series of individual image data is acquired according to our teachings, and then the compressive sensing reconstruction algorithms can be used to directly reconstruct the video sequence.

### Patterned Pixel Embodiment

In an alternative embodiment, a small number of densely packed large pixels are employed to create a summary of the signal (as opposed to the sparsely placed small pixels). Pixels are densely spaced when the optically active pixel area is comparably larger than the optically inactive area between the pixels

Among other benefits, the small number of densely packed large pixels may increase the detector signal to noise ratio (i.e, more photons will be captured if a dense array of large pixels is used). In this manner, both the PSF and p function are varied to obtain a good summary.

Since in this case, the size sup(p)>l, it is not possible to implement all possible random-tap filters Specifically, since F PSF*p, for a large and uniform pixel it may not be possible to implement a filter on a grid of step l that has one large tap with taps that are close to 0 immediately on both sides of it

In this case, a subset of random FIR filters may be used that is still sufficient to make a good summary of the signal, and that can be represented as F=PSF*p with size sup(p)>l.

It is essential for most optical signals of interest to sample (not systematically reject) high spatial frequency components of the signal. For that to be possible, the filter F should contain high spatial frequencies. Thus, p should contain high spatial frequencies. This is already the case, because even big pixels have sharp edges introducing high spatial frequencies into the spectrum of p. They can further be enhanced by appropriately masking or patterning the area of each pixel to introduce higher frequency content in p without blocking an excess number of photons (<=½ area).

FIG. 4 illustrates an exemplary implementation of a single exemplary patterned pixel 400 for the detector array 280 comprised of a small number of patterned, densely packed large pixels. As shown in FIG. 4, each sub-pixel element, such as sub-pixel 410, has a length, l, and the overall pixel 400 has a length, L. In addition, approximately half of the sub-pixels 410 are masked, for example, using a layer of reflecting, opaque or partially absorbing material on glass or other transparent substrate, to completely or partially block the transmission of the light through the sub-pixel 410. Generally, the embodiment shown in FIG. 4 aims to collect as much light as possible with different spatial frequencies. The embodiment of FIG. 4 provides a pseudo-random p function that includes high frequency components.

Many pseudo-random PSF functions can be used with such pixels 400 to create an appropriate filtering function, F, as would be apparent to a person of ordinary skill in the art For example, a set of pseudo-randomly located peaks spaced further apart than the pixel size can be employed.

If the camera is intended to operate over broad wavelength ranges, the PSF based on a given fixed waveplate profile will be different for different wavelengths An integral PSF should be considered, given by integrating the wavelength-dependent PSFs over the wavelength band(s) of detectors 270 used, such as R, G, and B pixels in the CCD of CMOS detector arrays. The waveplate should be chosen, using the calculation approaches and algorithms discussed herein, that gives sufficiently random integrated PSFs for each of the wavelength bands. Specifically, the waveplate should have enough power at high spatial frequencies to sample such frequencies efficiently.

Image Reconstruction

Signals can be reconstructed by solving a linear optimization problem. See, for example, E. Candés and T. Tao, “Near Optimal Signal Recovery from Random Projections and Universal Encoding Strategies,” IEEE Transactions on Information Theory, Vol. 52, No. 12, (December 2006) and D. Donoho, “Compressed Sensing,” IEEE Transactions on Information Theory, Vol 52, No. 4, (April 2006), each incorporated by reference herein. Alternatively, signals can be reconstructed using a greedy pursuit approach. See, for example, J. A Tropp and A. C. Gilbert, “Signal Recovery from Partial Information via Orthogonal Matching Pursuit,” IEEE Trans. Inform Theory (April, 2005), incorporated by reference herein

Generally, the reconstruction of a signal from the compressed data requires a nonlinear algorithm. Compressive Sensing techniques suggest greedy algorithms, such as a Orthogonal Matching Pursuit and Tree-Based Matching Pursuits (see, J A Tropp and A C. Gilbert) or optimization-based algorithms involving l₁ minimization (see, the linear optimization techniques referenced above).

It is to be understood that the embodiments and variations shown and described herein are merely illustrative of the principles of this invention and that various modifications may be implemented by those skilled in the art without departing from the scope and spirit of the invention.

We claim:

1. A method for acquiring image information, comprising:
modulating an incident light field using a waveplate having a pattern that spatially modifies one or more of a phase and an amplitude of said incident light field, wherein said waveplate is positioned substantially in a pupil plane of an optical system;
optically computing a transform between said modulated incident light field at a plane of said waveplate and said modulated incident light field at an image plane of said optical system; and
collecting image data at said image plane.

2. The method of claim 1, wherein said transform comprises one or more of a Fourier transform and a fractional Fourier transform.

3. The method of claim 1, wherein said waveplate has a fixed pattern to modify said one or more of a phase and an amplitude of said incident light field

4. The method of claim 1, wherein said waveplate has a reconfigurable pattern to modify said one or more of a phase and an amplitude of said incident light field

5. The method of claim 1, wherein said image information is one or more of two-dimensional and three-dimensional image information.

6. The method of claim 1, wherein said step of collecting image data further comprises the step of collecting said image data using a plurality of sparsely spaced small pixels or a sparsely spaced subset of densely packed small pixels

7. The method of claim 1, wherein said step of collecting image data further comprises the step of collecting said image data using a plurality of sparsely or densely packed large pixels.

8. The method of claim 7, wherein said pixels are patterned pixels.

9. The method of claim 1, wherein a measurement basis and a signal sparsity basis are mutually incoherent.

10. The method of claim 1, wherein a point spread function of said optical system with said waveplate is pseudorandom.

11. The method of claim 1, further comprising the steps of obtaining a time series of individual image data and directly reconstructing a video sequence.

12. An imaging system, comprising:
a waveplate for modulating an incident light field, wherein said waveplate has a pattern that spatially modifies one or more of a phase and an amplitude of said incident light field, wherein said waveplate is positioned substantially in a pupil plane of an optical system;
one or more optical elements for optically computing a transform between said modulated incident light field at a plane of said waveplate and an image plane of said optical system; and
a detector array for collecting image data at said image plane.

13. The imaging system of claim 12, wherein said transform comprises one or more of a Fourier transform and a fractional Fourier transform

14. The imaging system of claim 12, wherein said waveplate has one or more of a fixed pattern and a reconfigurable pattern to modify said one or more of a phase and an amplitude of said incident light field.

15. The imaging system of claim 12, wherein said image information is one or more of two-dimensional and three-dimensional image information.

16. The imaging system of claim 12, wherein said detector array comprises a plurality of sparsely spaced small pixels or a sparsely spaced subset of densely packed small pixels

17. The imaging system of claim 12, wherein said detector array comprises a plurality of sparsely or densely packed large pixels.

18. The imaging system of claim 12, wherein a point spread function of said optical system with said waveplate is pseudorandom

19. A method for acquiring image information, comprising:
spatially modifying one or more of a phase and an amplitude of an incident light field using a waveplate positioned substantially in a pupil plane of an optical system;
performing a transform using one or more optical elements between said modulated incident light field at a plane of said waveplate and an image plane; and
detecting image data at said image plane.
